(19) United States
(12) Patent Application Publication
(10) Pub. No.: US 2005/0077219 A1
(43) Pub. Date: Apr. 14, 2005

(54) Process and device for the treatment of effluents produced during wine manufacture

(76) Inventor: Samuel Paul Midgely, Havelock North (NZ)

Correspondence Address: SALTAMAR INNOVATIONS, 30 FERN LANE, SOUTH PORTLAND, ME, 04106, US

(21) Appl. No.: 10/498,285

(22) PCT Filed: Dec. 5, 2002
(86) PCT No.: PCT/NZ02/00269

(30) Foreign Application Priority Data
Dec. 6, 2001 (NZ) 514251

(51) Int. Cl. B01D 17/12

(52) U.S. Cl. 210/96.1; 210/121; 210/257.1

(57) ABSTRACT

Apparatus for processing effluent generated during wine making to separate solid matter from water in the effluent. The apparatus includes at least one detention tank (3) which includes aeration means (4) to receive effluent from the wine manufacture. A pump (7) pumps the effluent to a mixing tank (12) where the solid material falls into a hopper (34) and the separated water passes through a filtration means (14) and through a distribution valve (16) to a holding tank (20). Means (40, 41) are provided which act in conjunction with the distribution valve (16) to effect back washing of the filtration means (14).

### FIELD OF THE INVENTION

The manufacture of wines generates effluents which consists of water containing waste solids of a generally organic nature. The quantity of effluents can be quite substantial and this invention is concerned with a means by which the effluents can be efficiently and environmentally disposed. To do this satisfactorily it is necessary to treat the effluents to separate the solids, such as sludge, from the water.

1. Background to the Invention

It is known to utilise filtration systems to separate both organic and inorganic material from effluents but the wine industry introduces particular requirements which renders known apparatus inefficient or inapplicable.

2. Prior Art

One known form of apparatus is discussed in U.S. Pat. No. 6,024,877 which discloses a process consisting of pouring the effluents to be treated into a basin and actuating a recirculation circuit between the basin and an oxygenation reactor. The process includes providing a super oxygenation device when the volume of effluents becomes too great. The effluents are poured over a purification body and the purified elements are withdrawn until there is substantially nothing left in the basin but sludge.

U.S. Pat. No. 5,418,166 discloses a process for the biological treatment of effluents from wine cellars. The process consists in transferring the yeasts in the effluent to a medium which has a continuous supply or air and oxygen so that the yeasts which are placed under aerobic conditions consume the carbon substrates of the effluents.

### OBJECT OF THE INVENTION

It is an object of this invention to provide an improved process and apparatus for the treatment of effluents from wine manufacture.

It is also an object to provide apparatus which is capable of separating and remove organic material resulting from the wine manufacture from the water carrier.

It is a yet further object that the water separated from the organic material can be subsequently used for other purposes, much as irrigation.

### DISCLOSURE OF THE INVENTION

Accordingly one form of the invention may be said to comprise an apparatus for processing effluent comprising waste materials suspended in water resulting from the manufacture of wine, said apparatus including
at least one detention tank to receive the effluent,
means to conduct effluent within the detention tank to a mixing chamber to separate solid materials from the effluent,
filtration means to filter the water separated from the solid materials,
means to discharge the filtered water into a holding tank for disposal and
means to discharge sludge collected in the mixing chamber into a sludge tank for later disposal.

Preferably means are incorporated with the apparatus to enable back washing of at least the filtration system to be performed.

Preferably at least one detention tank includes aeration apparatus.

Preferably the apparatus includes pump means located in at least one detention tank to enable the effluent within the tank to be pumped into the conduit connected to the mixing chamber.

Preferably the pump means includes float means to initiate operation of the pump when the level of effluent within the detention tank reaches a predetermined point.

Preferably the apparatus includes means to regulate the transfer of sludge from the mixing chamber to the sludge tank.

Preferably the apparatus include mean to monitor the water from the solids in the mixture chamber and to operate a distribution valve to enable discharge of filtered water into the holding tank.

### DESCRIPTION OF THE DRAWING

FIG. 1 is a block diagram illustrating the various components of the apparatus the subject of the present invention.

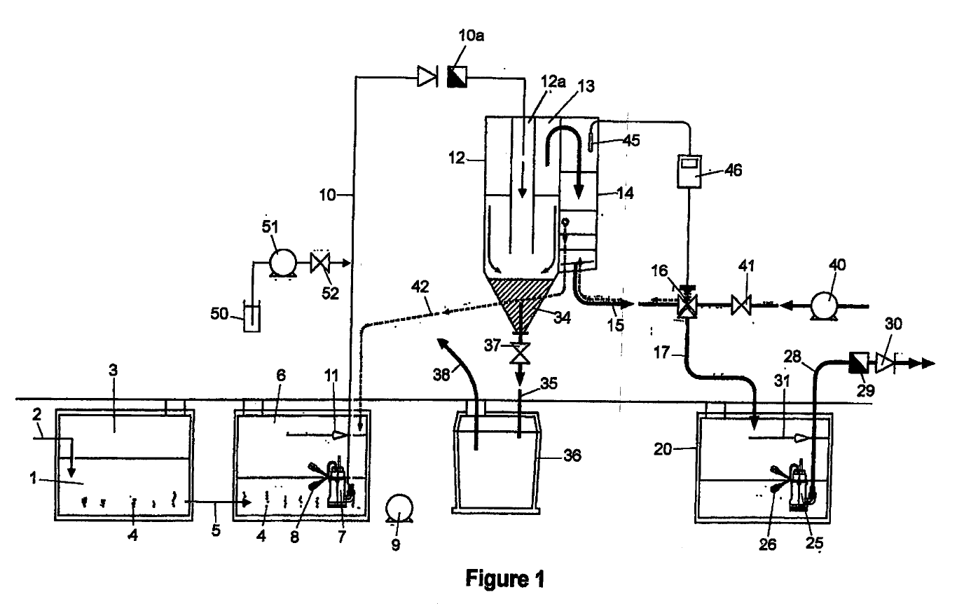

### DESCRIPTION OF A PREFERRED EMBODIMENT

As illustrated in the drawing, effluent in the form of wine waste 1 which is comprised essentially of organic matter suspended in water is led by way of the inlet 2 to the interior of a detention tank 3. The tank includes aeration means 4 to aerate the effluent within the tank which will have sufficient capacity that the effluent can be retained in the tank an appropriate time to enable the aeration to act on the yeasts and other organic matter to the desired degree. The detention tank 3 includes an outlet 5 which is positioned below the normal level of the effluent and which communicates with a second detention tank 6 which also includes aeration means 4.

An outlet mechanism 7 which is located within the second detention tank 6 preferably includes float means 8 which is so arranged that when the level of effluent within the tank rises above a predetermined level, the float means 8 will trip a switch (not shown in the drawings) which will initiate operation of a pump 9 to pump the effluent from the second detention tank 6 through a conduit 10 to a mixing chamber 12. Preferably a flow meter and a non-return, one way valve 10a is inserted in the conduit 10 to prevent effluent returning to the tank 6. Preferably also a holding tank 50 containing flocculant or the like is provided so that flocculant can be pumped by the pump 51 through a control valve 52 to inject flocculant into the effluent within the conduit 10.

When the amount of effluent within the second detention tank 6 falls below the predetermined level, the float means 8 will act to cease operation of the pump 9 and withdrawal of the effluent from the tank 6 will cease. Preferably an alarm 11 is installed to provide an indication if the level of effluent within the second detention tank 6 rises above a desired optimum mark.

The mixing chamber 12 is preferably a high performance clarifier with cyclonic tubes as it known in the art. Various forms of mixing chambers can be selected and the choice of an appropriate mixing chamber will be according to an individual preference. In the form of the mixing chamber illustrated, the outlet of the conduit 10 extends within the mixing chamber 12a where it can discharge the effluent within the chamber.

The effluent which is thoroughly mixed within the mixing chamber 12 will flow into an outlet chamber 13 and then into a gravity filtration means 14. Following filtration resulting from passing through the filtration means, the water is led through the discharge pipe 15 to a distribution valve 16. In one configuration the distribution valve 16 will direct the filtered water though a conduit 17 into a holding tank 20 which preferably is provided with an internally located outlet discharge means 25. The discharge means 25 may include a float 26 so that when the level of treated water within the holding tank 20 rises about a predetermined point, the float means will trip a switch to initiate a pump to discharge the treated water though a discharge line 28 to a distant location. Preferably but not necessarily the discharge line can include a flow meter 29 to indicate the volume of treated water passing through the discharge line 28. A one way valve 30 may also be included in the discharge line. A suitable alarm illustrated at 31 is also preferably installed within the holding tank 20 to give an alarm or signal should the level of treated water within the tank rise above a predetermined point.

The mixing chamber 12 includes a hopper 34 at the lower end of the chamber 12 into which particulate matter which is separated from the effluent discharged into the chamber through the conduit 10 will fall. The contents of the hopper 34 can be discharged through a sludge pipe 35 into a sludge tank 36. Suitable valve means 37 is provided to enable the discharge of the sludge from the hopper 34 to be regulated. Disposal of the sludge within the sludge tank 36 cam be conveniently arranged though a sludge discharge line 38 for remote disposal of the sludge.

Means are also preferably provided to enable the system to be cleaned. In a highly preferred form this may consist of a back wash arrangement by which suitable cleaning fluids can be passed backwards through the unit. To effect this a pump 40 is connected through a valve 41 to the distribution valve 16. Upon appropriate operation of the valve 16 the cleaning fluid will be forced by the pump 40 trough the discharge pipe 15 into the filtration means 14. A back wash discharge conduit 42 is provided from the filtration means 14 so that any matter within the filtration unit can be returned to the second detention tank 6 for further processing.

Control means is also preferably provided to regulate the flow of treated water from the filtration unit. One form of the control means may consist of a probe 45 situated within the mixing chamber 12 and which is electrically connected to a control panel 46 which is in turn is connected to the distribution valve 16 to enable that valve to be configured as required.

Having read the specification it will be apparent to those skilled in this particular art that variations and amendments can be made to various functional features and still come within the general scope of the invention. All such variations and amendments are intended to be included within the scope of this specification.

1-7. (canceled)

8. An apparatus for processing effluent resulting from wine manufacturing, said effluent comprising solid materials suspended in water, said apparatus comprising:
at least one detention tank to receive said effluent;
a mixing chamber coupled to said detention tank, said mixing chamber constructed to at least partially separate solid materials from said effluent;
a filtration unit coupled to said mixing tank, for filtering water from said mixing chamber, said filtration unit having a water discharge or discharging filtered water from said filtration unit;
a sludge discharge coupled to said mixing chamber for discharging sludge collected in said mixing chamber;
wherein said water discharge is selectively coupled to said detention tank to enable matter within said filtration unit to be returned to said detention tank.

9. A process for processing effluent resulting form wine manufacturing, said effluent containing solid materials suspended in water, said process comprising the steps of:
depositing said effluent in a detention tank;
conducting said effluent into a mixing chamber;
separating solid materials from said water in said mixing chamber;
filtering said water;
controllably retuning at least a portion of said filtered water to said detention tank.
